(19) United States
(12) Patent Application Publication
(10) Pub. No.: US 2012/0210568 A1
(43) Pub. Date: Aug. 23, 2012

(54) UNINSTALLER FOR TAKING OUT BRAKE CALIPER PISTON

(76) Inventor: A-Mei YANG, Taichung City (TW)

(21) Appl. No.: 13/031,231

(22) Filed: Feb. 20, 2011

(51) Int. Cl. B23P 19/00

(52) U.S. Cl. 29/700

(57) ABSTRACT

An uninstaller for taking out brake caliper piston includes: a handle; an engagement member having a column-shaped plug section with a predetermined original outer diameter, one end of the plug section being connected with the handle, the engagement member further having an expander for expanding outer diameter of the plug section, the expander being disposed in the plug section and movable between a restored position and an expanded position, when the expander is positioned in the restored position, the plug section being kept with the original outer diameter, when the expander is positioned in the expanded position, the plug section having an expanded outer diameter larger than the original outer diameter; and a drive section for driving the expander to reciprocally move between the restored position and the expanded position.

### BACKGROUND OF THE INVENTION

1. Field of the Invention

The present invention relates generally to a vehicle service tool, and more particularly to an uninstaller for taking out brake caliper piston.

2. Description of the Related Art

In the operation of a hydraulic disc brake system, the piston in the brake caliper main body is generally driven by high-pressure fluid to push the linings for clamping the disc and achieving braking effect. Therefore, it is important to keep the piston smoothly reciprocally movable in maintenance of the brake system.

Substantially, when servicing the piston of the brake caliper, as shown in FIG. 1, a tool such as a spray gun 1 is serially connected to the brake oil pipe connector 3 of the brake caliper 2 for filling exterior compressed air into the brake caliper 2. By means of the pressure of the air, the piston 4 is pushed out of the piston chamber of the brake caliper main body for a serviceman to perform the necessary service process.

In the above maintenance process, an air compressor must be arranged in the working site. Moreover, in operation, it is necessary for the serviceman to cautiously slowly fill the high-pressure air into the piston chamber of the brake caliper main body to slowly forcedly move the piston out of the piston chamber. In case a great amount of compressed air is instantaneously filled into the piston chamber, the piston will abruptly move out of the piston chamber. Under such circumstance, the brake caliper main body and the piston itself may be damaged. Accordingly, in order to ensure safety of the components, a suitable buffer material 5 is often previously filled between the piston and the brake caliper main body.

Please refer to FIG. 2. When maintaining a brake caliper 6 with multiple pistons 7, it is necessary to take out all the pistons 7 at the same time. In the case that any of the pistons 7 is first taken out, the respective piston chambers of the brake caliper main body will communicate with the atmosphere. Under such circumstance, it will be impossible to take out the other pistons with the high-pressure air. Therefore, when only one of the pistons needs to be maintained, the serviceman still needs to take out all the pistons. After the maintenance of the single piston is completed, all the pistons are then installed onto the brake caliper main body. Such operation is quite troublesome and inconvenient.

### SUMMARY OF THE INVENTION

It is therefore a primary object of the present invention to provide an uninstaller for taking out brake caliper piston. With the uninstaller, a serviceman can conveniently take out the brake caliper piston in maintenance process.

It is a further object of the present invention to provide the above uninstaller for taking out brake caliper piston. The uninstaller is widely applicable to various sizes of brake caliper pistons.

To achieve the above and other objects, the uninstaller for taking out brake caliper piston of the present invention includes: a handle; an engagement member having a column-shaped plug section with a predetermined original outer diameter, one end of the plug section being connected with the handle, the engagement member further having an expander for expanding outer diameter of the plug section, the expander being disposed in the plug section and movable between a restored position and an expanded position, when the expander is positioned in the restored position, the plug section being kept with the original outer diameter, when the expander is positioned in the expanded position, the plug section having an expanded outer diameter larger than the original outer diameter; and a drive section for driving the expander to reciprocally move between the restored position and the expanded position.

The present invention can be best understood through the following description and accompanying drawings, wherein:

### BRIEF DESCRIPTION OF THE DRAWINGS

FIG. 1 is a perspective view showing the uninstallation of the piston of a conventional single-piston brake caliper;

FIG. 2 is a perspective view showing the uninstallation of the pistons of a conventional multi-piston brake caliper;

FIG. 3 is a perspective exploded view of a preferred embodiment of the present invention;

FIG. 4 is a perspective assembled view of the preferred embodiment of the present invention;

FIG. 5 is a sectional view taken along line a-a of FIG. 4, showing the plug section of the present invention in an original state;

FIG. 6 is a sectional view taken along line a-a of FIG. 4, showing the plug section of the present invention in an expanded state;

FIG. 7 is a sectional view showing the use of the preferred embodiment of the present invention, in which the plug section is inserted into the brake caliper piston;

FIG. 8 is a sectional view showing the use of the preferred embodiment of the present invention, in which the outer circumference of the plug section tightly abuts against the inner circumference of the brake caliper piston;

FIG. 9 is a sectional view showing the use of the preferred embodiment of the present invention in another state; and

FIG. 10 is a sectional view showing the use of the preferred embodiment of the present invention in still another state.

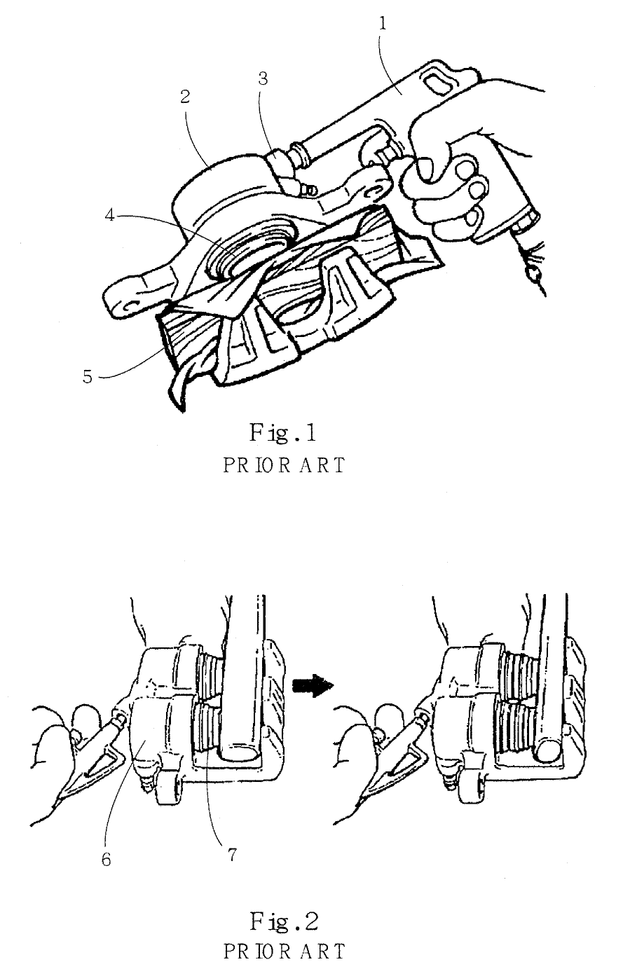

### DETAILED DESCRIPTION OF THE PREFERRED EMBODIMENTS

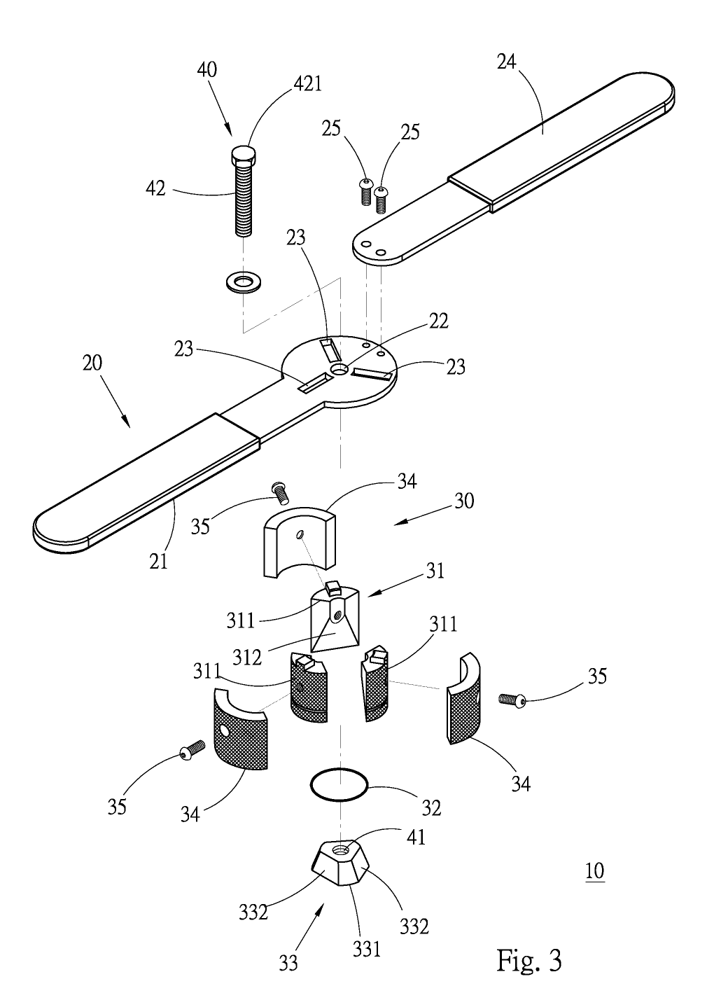

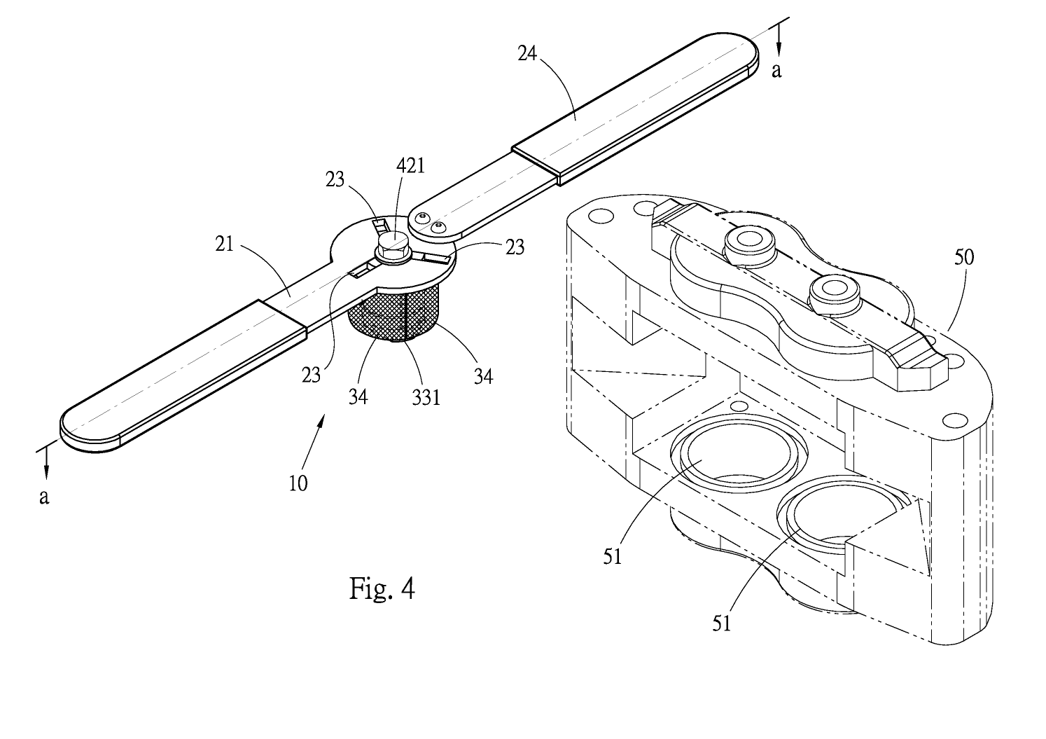

Please refer to FIGS. 3 to 6. According to a preferred embodiment, the uninstaller 10 for taking out brake caliper piston of the present invention includes a handle 20, an engagement member 30 and a drive section 40.

The handle 20 has a grip body 21 in the form of an elongated plate. One end of the grip body 21 is formed with a through hole 22. Three slide slots 23 are formed through the end of the grip body 21 at 120-degree angular intervals. The slide slots 23 radially outward extend and are centered at the axis of the through hole 22. The handle 20 further has an extension body 24 in the form of an elongated plate. One end of the extension body 24 is fixedly connected with the end of the grip body 21 by means of fixing screws 25.

The engagement member 30 has a column-shaped plug section 31. The plug section 31 is composed of three separable symmetrical block bodies 311, which are attached to and combined with each other. One end of the plug section 31 is connected with the end of the grip body 21. A resilient ring body 32 is coaxially fitted around the plug section 31. An expander 33 is slidably disposed in the plug section 31 between the block bodies 311. The expander 33 is reciprocally movable along the axis of the plug section 31 between an expanded position and a restored position. The engagement member 30 further has three pad bodies 34 in the form of arcuate plates. The pad bodies 34 are respectively connected with the corresponding block bodies 311 by means of fixing screws 35 with inner concave faces of the pad bodies 34 abutting against outer convex faces of the corresponding block bodies 311.

To speak more specifically, the block bodies 311 are attached to and combined with each other to form the column-shaped plug section 31, which has an original outer diameter d. The ring body 32 provides resilient force to keep the plug section 31 in a state with the original outer diameter d. One end of each block body 311 is inlaid in a corresponding slide slot 23 and slidable within the slide slot 23 along a length thereof. Accordingly, when the block bodies 311 are displaced to separate from each other, the outer diameter of the column-shaped plug section 31 is enlarged with the displacement of the block bodies 311. That is, the inner diameter of the ring body 32 is enlarged with the displacement of the block bodies 311. In this case, the outer diameter of the column-shaped plug section 31 becomes larger than the original outer diameter d.

Moreover, the plug section 31 has three push faces 312 in the form of plane faces. The three push faces 312 are respectively obliquely formed on inner sides of the block bodies 311 by the same angle.

The three push faces 312 are centered at the axis of the plug section 31 with the expander 33 held between the push faces 312.

The expander 33 has a slide body 331 slidably disposed between the block bodies 311 and reciprocally movable between the expanded position and the restored position. Three oblique thrust faces 332 are formed on a periphery of the slide body 331. The three thrust faces 332 respectively abut against the corresponding push faces 312.

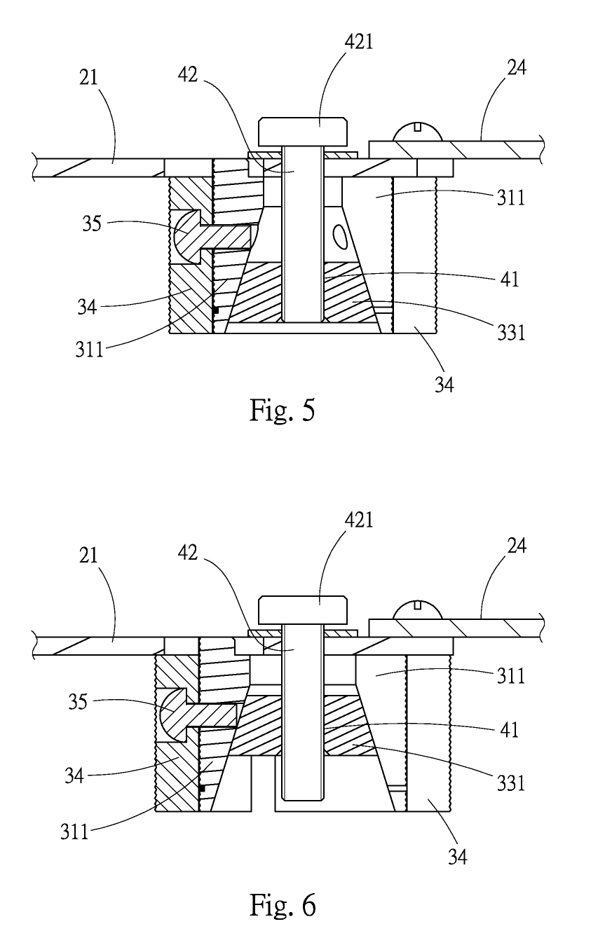

Accordingly, as shown in FIG. 5, when the expander 33 is positioned in the restored position, the block bodies 311 are combined with each other in adjacency to each other. Under such circumstance, the plug section 31 is kept with the original outer diameter. As shown in FIG. 6, when the expander 33 is positioned in the expanded position, the thrust faces 332 and the push faces 312 are slid along each other to separate the block bodies 311. In this case, the plug section 31 has an expanded outer diameter d′ larger than the original outer diameter d, which is defined by the outer arcuate faces of the block bodies 311.

The drive section 40 has a threaded hole 41 formed through the slide body 331. The axis of the threaded hole 41 coincides with the axis of the plug section 31. A threaded rod 42 is coaxially screwed in the threaded hole 41. One end of the threaded rod 42 passes through the through hole 22 to fixedly connect with a nut 421, whereby the end of the threaded rod 42 is restrictedly located on the grip body 21. Accordingly, by means of rotating the threaded rod 42, the slide body 331 is drivable to reciprocally move between the restored position and the expanded position.

According to the above arrangement, the use of the uninstaller 10 is variable in accordance with different requirements. The use of the uninstaller 10 is described as follows with three use aspects taken as examples:

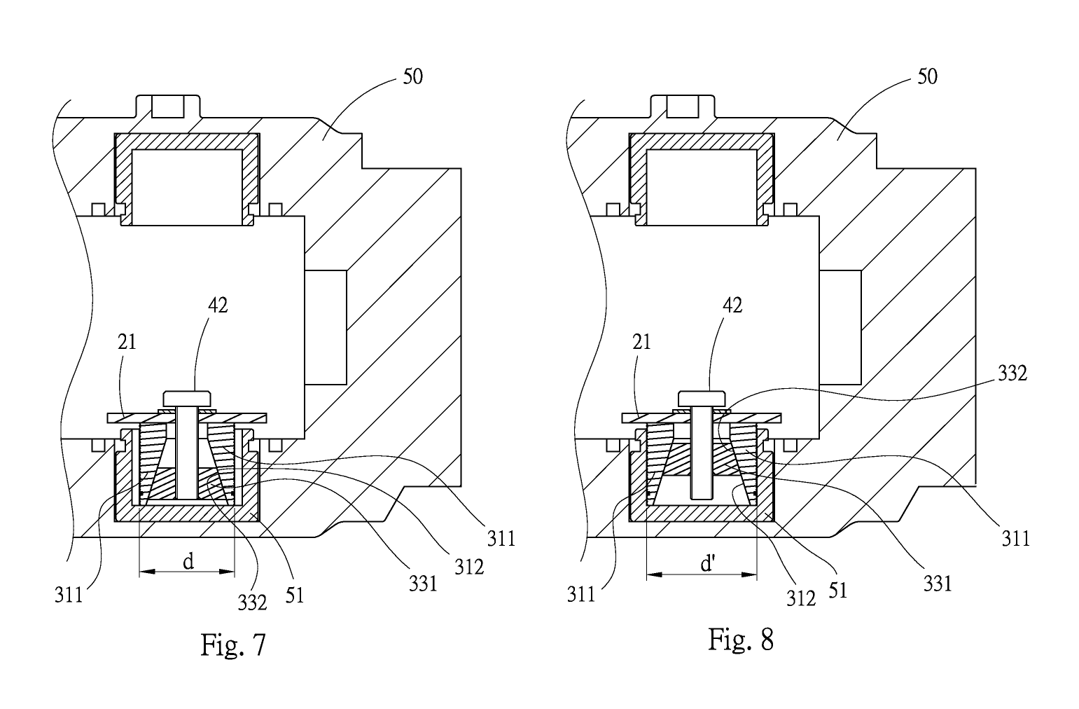

First, referring to FIGS. 7 and 8, in a common use state, the other end of the plug section 31 with the original outer diameter d is inserted into the piston 51 of the brake caliper 50. Then the threaded rod 421 is rotated with a tool to move the expander 33 from the restored position to the expanded position. At this time, the outer diameter of the plug section 31 is enlarged to make the outer arcuate faces of the block bodies 311 tightly abut against the inner circumference of the piston 51. Accordingly, a serviceman can apply a force to the grip body 21 of the handle 20 to extract the piston 51 out of the piston chamber of the caliper main body 50.

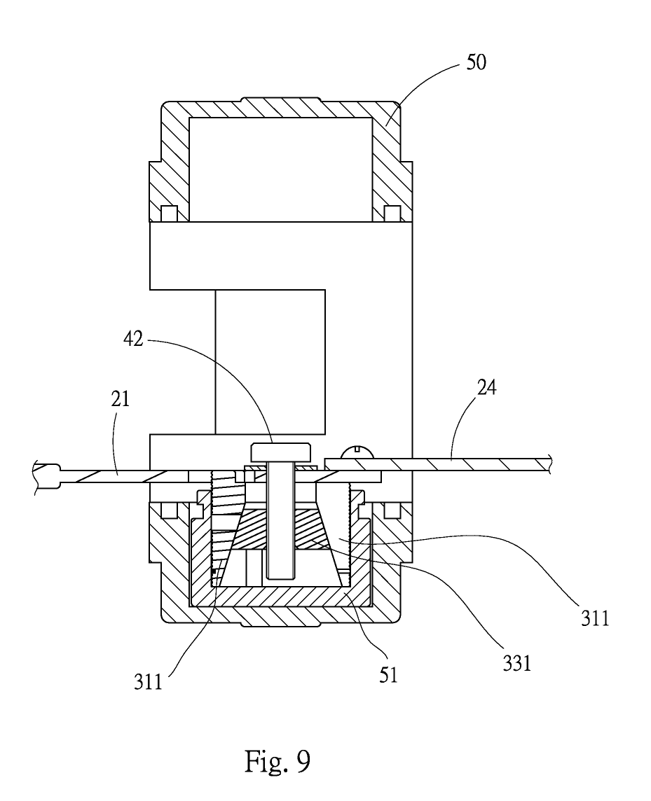

Second, referring to FIG. 9, in order to make it easier for the serviceman to hold the handle 20 and extract the piston 51 out of the piston chamber, the extension body 24 is fixedly connected with the grip body 21 with the engagement member 30 positioned the grip body 21 and the extension body 24. Accordingly, the serviceman can hold the extension body and the grip body with both hands to more conveniently extract the piston out of the piston chamber.

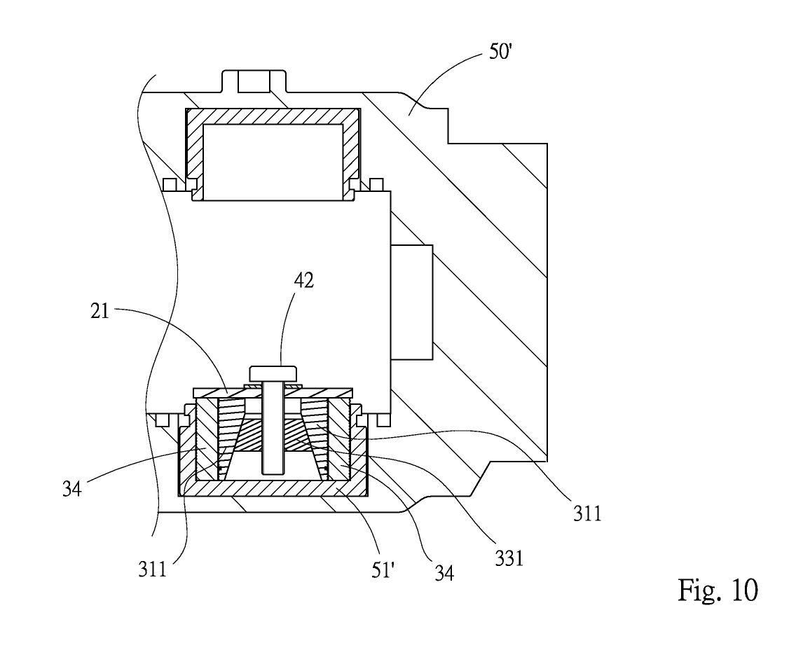

Third, referring to FIG. 10, in the case that the piston 51′ of the brake caliper 50′ to be serviced has a size much larger than the maximum expanded outer diameter of the plug section 31, the pad bodies 34 can be respectively installed on the outer arcuate faces of the block bodies 311 to enlarge the original outer diameter d. Under such circumstance, the maximum expanded outer diameter of the plug section 31 is increased. Accordingly, the application range of the uninstaller 10 is widened to achieve more economic profit.

The above embodiment is only used to illustrate the present invention, not intended to limit the scope thereof. Many modifications of the above embodiment can be made without departing from the spirit of the present invention.

For example, in order to enhance the engagement strength between the engagement member 30 and the inner circumference of the piston, the outer arcuate faces of the block bodies 311 and the pad bodies 34 can be formed with recessed stripes. Also, the structure for driving the expander 33 is not limited to the above embodiment. Alternatively, the slide body can have a conic shape with a conic circumferential face as the thrust face. Also, the push face can be a tapered face and the thrust face can be a tapered face corresponding to the push face for snugly abutting against the push face.

What is claimed is:

1. An uninstaller for taking out brake caliper piston, comprising:
a handle;
an engagement member having a column-shaped plug section with a predetermined original outer diameter, one end of the plug section being connected with the handle, the engagement member further having an expander for expanding outer diameter of the plug section, the expander being disposed in the plug section and movable between a restored position and an expanded position, when the expander is positioned in the restored position, the plug section being kept with the original outer diameter, when the expander is positioned in the expanded position, the plug section having an expanded outer diameter larger than the original outer diameter; and
a drive section for driving the expander to reciprocally move between the restored position and the expanded position.

2. The uninstaller for taking out brake caliper piston as claimed in claim 1, wherein the plug section has a cylindrical shape and includes at least two symmetrical block bodies, the expander being held between the block bodies, when the expander is positioned in the restored position, the block bodies being combined with each other in adjacency to each other, whereby outer arcuate faces of the block bodies define the original outer diameter of the plug section, when the expander is positioned in the expanded position, the block bodies being separated from each other to enlarge the outer diameter of the plug section, which is defined by the outer arcuate faces of the block bodies.

3. The uninstaller for taking out brake caliper piston as claimed in claim 2, wherein one end of each block body is slidably connected with the handle.

4. The uninstaller for taking out brake caliper piston as claimed in claim 3, wherein the handle includes a grip body, at least two slide slots being formed through the grip body with their length normal to an axis of the plug section, one end of each block body being slidably inlaid in a corresponding slide slot.

5. The uninstaller for taking out brake caliper piston as claimed in claim 2, wherein the block bodies have outer faces opposite to each other, the outer faces of the block bodies being formed with recessed stripes for enhancing frictional force between the block bodies and an inner circumference of the brake caliper piston in abutment with the block bodies.

6. The uninstaller for taking out brake caliper piston as claimed in claim 2, wherein the engagement member further includes a resilient ring body coaxially fitted around the plug section, the resilient ring body serving to provide a resilient force for keeping the block bodies combined with each other in adjacency to each other.

7. The uninstaller for taking out brake caliper piston as claimed in claim 2, wherein the plug section further has at least two oblique push faces respectively formed on inner sides of the block bodies opposite to each other, the expander being held between the push faces.

8. The uninstaller for taking out brake caliper piston as claimed in claim 7, wherein the expander has a slide body positioned between the push faces, the slide body being reciprocally movable along the axis of the plug section between the restored position and the expanded position, at least one oblique thrust face being formed on a periphery of the slide body in abutment with the push faces, whereby when the slide body is moved from the restored position to the expanded position, the thrust face pushes the block bodies to move outward in a direction normal to the axis of the plug section so as to enlarge the outer diameter of the plug section.

9. The uninstaller for taking out brake caliper piston as claimed in claim 8, wherein the slide body has a conic shape with a conic circumferential face as the thrust face and the push face is a tapered face corresponding to the thrust face for snugly abutting against the thrust face.

10. The uninstaller for taking out brake caliper piston as claimed in claim 7, wherein the push faces are oblique plane faces inclined from the axis of the plug section by a predetermined angle, the expander having at least two thrust faces, the thrust faces being oblique plane faces inclined from the axis of the plug section by a predetermined angle, the thrust faces respectively abutting against the corresponding push faces.

11. The uninstaller for taking out brake caliper piston as claimed in claim 1, wherein the drive section has a threaded hole formed on the expander, the threaded hole having an axis coinciding with the axis of the plug section, the drive section further having a threaded rod coaxially screwed in the threaded hole, one end of the threaded rod being passed through the handle being restrictedly located on the handle, whereby by means of rotating the threaded rod, the expander is drivable to reciprocally move along an axis of the threaded rod between the restored position and the expanded position.

12. The uninstaller for taking out brake caliper piston as claimed in claim 1, wherein the engagement member further includes at least two pad bodies in the form of arcuate plates, each pad body having an inner concave face, the pad bodies being fixedly connected with the plug section with the inner concave faces of the pad bodies attached to a circumference of the plug section, whereby when the expander is positioned in the restored position, the pad bodies serve to enlarge the original outer diameter of the plug section.

13. The uninstaller for taking out brake caliper piston as claimed in claim 1, wherein the handle has a grip body with a predetermined length and an extension body with a predetermined length, one end of the grip body being connected with one end of the plug section, one end of the extension body being fixedly connected with the end of the grip body.

14. The uninstaller for taking out brake caliper piston as claimed in claim 8, wherein the push faces are oblique plane faces inclined from the axis of the plug section by a predetermined angle, the expander having at least two thrust faces, the thrust faces being oblique plane faces inclined from the axis of the plug section by a predetermined angle, the thrust faces respectively abutting against the corresponding push faces.

15. The uninstaller for taking out brake caliper piston as claimed in claim 2, wherein the drive section has a threaded hole formed on the expander, the threaded hole having an axis coinciding with the axis of the plug section, the drive section further having a threaded rod coaxially screwed in the threaded hole, one end of the threaded rod being passed through the handle being restrictedly located on the handle, whereby by means of rotating the threaded rod, the expander is drivable to reciprocally move along an axis of the threaded rod between the restored position and the expanded position.

16. The uninstaller for taking out brake caliper piston as claimed in claim 2, wherein the engagement member further includes at least two pad bodies in the form of arcuate plates, each pad body having an inner concave face, the pad bodies being fixedly connected with the plug section with the inner concave faces of the pad bodies attached to a circumference of the plug section, whereby when the expander is positioned in the restored position, the pad bodies serve to enlarge the original outer diameter of the plug section.
